(19) United States
(12) Patent Application Publication
(10) Pub. No.: US 2023/0351721 A1
(43) Pub. Date: Nov. 2, 2023

(54) SCALABLE FEATURE STREAM

(71) Applicant: GUANGDONG OPPO MOBILE TELECOMMUNICATIONS CORP., LTD., Dongguan (CN)

(72) Inventors: Marek DOMANSKI, Poznan (PL); Tomasz GRAJEK, Poznan (PL); Slawomir MACKOWIAK, Poznan (PL); Slawomir ROZEK, Poznan (PL); Olgierd STANKIEWICZ, Poznan (PL); Jakub STANKOWSKI, Poznan (PL)

(21) Appl. No.: 18/217,865

(22) Filed: Jul. 3, 2023

Related U.S. Application Data
(63) Continuation of application No. PCT/CN2021/072771, filed on Jan. 19, 2021.

(30) Foreign Application Priority Data
Jan. 4, 2021 (EP) 21461505.6

(51) Int. Cl. G06V 10/44; G06V 10/771; G06V 10/764; G06V 10/75

(52) U.S. Cl. CPC G06V 10/449; G06V 10/771; G06V 10/764; G06V 10/751

(57) ABSTRACT

A visual feature processing method in an encoding device is disclosed. The visual feature processing method comprises: performing feature extraction from picture data to be encoded based on a predetermined feature extraction method to thereby obtain a set of extracted features; sorting the features in the set of extracted features based on a predetermined criterion; iteratively dividing the sorted set of extracted features in a plurality of subsets of features, said plurality of subsets of features comprising a first subset of features and at least one further subset of features, wherein the first subset of features is assigned a priority value which is higher than the priority value of the at least one further subset of features; and multiplexing the features of each subset of features for outputting for compressing, wherein the multiplexing is based on the priority value assigned to each subset of features.

### CROSS-REFERENCE TO RELATED APPLICATIONS

This is a continuation application of International Patent Application No. PCT/CN2021/072771, filed on Jan. 19, 2021, entitled “SCALABLE FEATURE STREAM”, which claims the benefit of priority to European Application No. 21461505.6 filed on Jan. 4, 2021, both of which are hereby incorporated by reference in their entireties.

### BACKGROUND

Coding or encoding is used in a wide range of applications which involve not only still pictures but also moving pictures such as picture streams and videos. Examples of such applications include transmission of still pictures over wired and wireless networks, video transmission and/or video streaming over wired or wireless networks, broadcasting digital television signals, real-time video conversations such as video-chats or video-conferencing over wired or wireless networks and storing of pictures and videos on portable storage media such as DVD disks or Blue-ray disks.

Coding usually involves encoding and decoding. Encoding is the process of compressing and potentially also changing the format of the content of the picture or the video. Encoding is important as it reduces the bandwidth needed for transmission of the picture or the video over wired or wireless networks. Decoding on the other hand is the process of decoding or uncompressing the encoded or compressed picture or video. Since encoding and decoding is applicable on different devices, standards for encoding and decoding called codecs have been developed. A codec is in general an algorithm for encoding and decoding of pictures and videos.

Further to coding of pictures and videos for transmission over wired or wireless networks, the need for analysis of pictures and videos is also rapidly increasing in the past years. Analysis of pictures and videos relates to analysis of the content of the pictures and the videos for detection, search or classification of objects in the pictures and the videos.

For analysis of pictures and videos normally feature extraction is applied. Feature extraction involves detection and/or extraction of features from the original picture or the video. For video, normally the feature extraction involves extraction of features from frames of the video. One frame in general may also be called a picture. The extracted features are normally also encoded or compressed and a stream of (compressed) features, normally in a form of a bitstream, is transmitted to the decoder side.

At the decoding side the received compressed features are decoded. Then a process for classification (also known as recognition) of objects (object classification process) based on the decoded features is carried out. The object classification/recognition process at the decoding side is normally time consuming as it requires an evaluation and sorting of the decoded features which in turn requires large amount of computational resources at the decoding side. If the decoding side does not have the required computational resources, the decoding side may even entirely fail in performing the object classification/recognition process.

Therefore, there is a need for an increased functionality of the stream of features transmitted from the encoding side to the decoding side so that the decoding side can perform the process of classification in a time-efficient manner without the need for additional computational power for evaluation and sorting of the decoded features.

### SUMMARY

The present disclosure relates to the technical field of compression and transmission of visual information. More specifically the present disclosure relates to a device and method for coding of visual features extracted from pictures or videos.

The mentioned problems and drawbacks are addressed by the subject matter of the independent claims. Further preferred embodiments are defined in the dependent claims.

According to an aspect of the present disclosure there is provided a visual feature processing method in an encoding device, the visual feature processing method comprising: performing feature extraction from picture data to be encoded based on a predetermined feature extraction method to thereby obtain a set of extracted features; sorting the features in the set of extracted features based on a predetermined criterion; iteratively dividing the sorted set of extracted features in a plurality of subsets of features, said plurality of subsets of features comprising a first subset of features and at least one further subset of features, wherein the first subset of features is assigned a priority value which is higher than the priority value assigned to the at the at least one further subset of features; and multiplexing the features of each subset of features for outputting for compressing, wherein the multiplexing is based on the priority value assigned to each subset of features.

According to an aspect of the present disclosure there is provided an encoder device for visual feature processing, said encoder device comprising at least one processor and an access to a memory resource to obtain code that instructs said at least one processor during operation to: perform feature extraction from picture data to be encoded based on a predetermined feature extraction method to thereby obtain a set of extracted features; sort the features in the set of extracted features based on a predetermined criterion; iteratively divide the sorted set of extracted features in a plurality of subsets of features, said plurality of subsets of features comprising a first subset of features and at least one further subset of features, wherein the first subset of features is assigned a priority value which is higher than the priority value assigned to the at the at least one further subset of features; and multiplexing the features of each subset of features for outputting for compressing, wherein the multiplexing is based on the priority value assigned to each subset of feature.

According to an aspect of the present disclosure there is provided a visual feature processing method in a decoding device the method comprising: receiving a features bitstream from an encoding device, said feature bitstream being generated by compressing a plurality of subsets of features, said plurality comprising a first subset of features and at least one further subset of features, wherein the first subset of features is assigned a priority value which is higher than the priority value assigned to the at the at least one further subset of features, the method further comprising: decompressing the received features bitstream to thereby obtain decompressed plurality of subsets of features; selecting at least one subset of features from the plurality of subsets of features based on the priority value assigned to each subset of features and the processing capabilities of the decoding device.

According to an aspect of the present disclosure there is provided a decoding device for visual feature processing, said decoder device comprising at least one processor and an access to a memory resource to obtain code that instructs said at least one processor during operation to: receive a features bitstream from an encoding device, said features bitstream being generated by compressing a plurality of subsets of features, said plurality comprising a first subset of features and at least one further subset of features, wherein the first subset of features is assigned a priority value which is than the priority value assigned to the at the at least one further subset of features, decompress the received feature bitstream to thereby obtain decompressed plurality of subsets of features; select at least one subset of features from the plurality of subsets of features based on the priority value assigned to each subset of features and the processing capabilities of the decoding device.

### BRIEF DESCRIPTION OF THE DRAWINGS

Embodiments of the present disclosure, which are presented for better understanding the inventive concepts, but which are not to be seen as limiting the disclosure, will now be described with reference to the figures in which:

FIG. 1A shows a schematic view of the general conventional configuration;

FIG. 1B shows a schematic view of a general use case as in the conventional arts as well as an environment for employing embodiments of the present disclosure;

FIG. 2 shows schematically an example of an object classification according to the embodiment of the present disclosure;

FIG. 3 shows schematically an example of an object classification according to the embodiment of the present disclosure;

FIG. 4A shows schematically an example of an object classification according to the embodiment of the present disclosure;

FIG. 4B shows schematically an example of an object classification according to the embodiment of the present disclosure;

FIG. 5 shows a schematic view of the functional components of the encoding device according to an embodiment of the present disclosure;

FIG. 6 shows a schematic view of the functional components of the encoding device according to the embodiment of the present disclosure;

FIG. 7 shows a flowchart of a method according to the embodiment of the present disclosure.

FIG. 8 shows a flowchart of a method according to the embodiment of the present disclosure.

### DETAILED DESCRIPTION

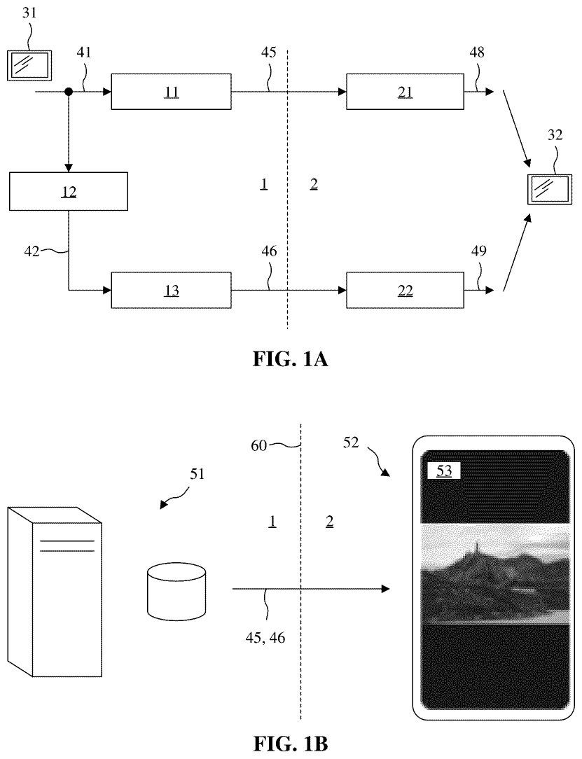

FIG. 1A shows a schematic view of the conventional configuration. In general, both the original picture and the extracted features are encoded or compressed and transmitted in a form of a bitstream to the decoder side. On the decoding side the encoded original picture and the encoded extracted features are decoded in order to obtain reconstructed (decoded) picture and reconstructed (decoded) features.

More specifically, picture data 41, forming or being part of a picture 31, a picture stream or a video, is processed at an encoder side 1. The picture data 41 is input to both an encoder 11 as well as to a feature extractor 12, which generates original features 42. The latter are also encoded by means of a feature encoder 13, so that two bitstreams, a picture bitstream 45 and a feature bitstream 46 are generated on the encoding side 1. Generally, the term picture data in the context of the present disclosure shall include all data that contains, indicates and/or can be processed to obtain an image, a picture, a stream of pictures/images, a video, a movie, and the like, wherein, in particular, a stream, video or a movie may contain one or more pictures. Such data may also be called a visual data.

These two bitstreams 45, 46 are conveyed from the encoder side 1 to a decoder side 2 by, for example, any type of suitable data connection, communication infrastructure and applicable protocols. For example, the bitstreams 45, 46 are provided by a server and are conveyed over the Internet and one or more communication network(s) to a mobile device, where the streams are decoded and where corresponding display data is generated so that a user can watch the picture on a display device of that mobile device.

On the decoder side 2, the two bitstreams are received and recovered. A picture bitstream decoder 21 decodes the picture bitstream 45 so as to generate one or more reconstructed pictures, and a feature bitstream decoder 22, decodes the feature bitstream 46 so as to generate one or more reconstructed features. Both the pictures as well as the features form the basis for generating corresponding reconstructed picture 32 to be displayed and/or used and/or processed at the decoder side's 2 end.

FIG. 1B shows a further schematic view of a general use case as in the conventional arts as well as an environment for employing embodiments of the present disclosure. On the decoding side 1 there is arranged equipment 51, such as data centers, servers, processing devices, data storages and the like that is arranged to store picture data and generate picture and feature bitstreams 45, 46. The bitstreams 45, 46 are conveyed via any suitable network and data communication infrastructure 60 toward the decoding side 2, where, for example, a mobile device 52 receives the bitstreams 45, 46, decodes them and generates display data for displaying one or more pictures on a display 53 of the (target) mobile device 52 or be subjected to other processing on the mobile device 52.

As described above, picture data as well as the extracted features are encoded on the encoding side so as to generate bitstreams 45, 46. These bitstreams 45, 46 are conveyed over data communication to a decoding side where the streams are decoded so as to reconstruct the picture data 48 and the features 49. Then a process for classification (also known as recognition) of objects (object classification process) based on the decoded (reconstructed) features is carried out. As elaborated above the object classification/recognition process at the decoding side is normally time consuming as it requires an evaluation and sorting of the decoded features at the decoding side which in turn requires large amount of computational resources. If the decoding side does not have the required computational resources, the decoding side may entirely fail in performing the classification/recognition process.

Therefore, the present disclosure aims at obtaining faster classification of relevant objects at the decoding side so that the decoding side can perform the process of object classification in a time-efficient manner without the need for additional computational power for evaluation and sorting of the decoded features.

For this, the present disclosure proposes an increased functionality of the feature stream transmitted from the encoding side to the decoding side.

More specifically, the present disclosure proposes organization of the feature stream transmitted from the encoding side to the decoding side into a scalable feature stream so that the process of object classification at the decoding side can be carried out according to certain rules.

For this purpose, classification processes are additionally carried out on the encoding side in order to select valuable features and processes of feature selection and classification in order to organize the stream of features are additionally carried out. Valuable features may be understood in the sense of the value of features with respect to unambiguity of classification.

The whole extracted features (also called extracted feature set) on the encoding side is sent to the decoding side. The feature bitstream decoder 22 decodes the whole stream of features and, based on additional information, which is extra or added information (which may be implicit or explicit information) to the features bitstream in difference to the conventional encoding of features, contained in the stream, knows which features should be taken into account first in the classification process to get one of the following functionality of processes as elaborated further below. The feature bitstream decoder 22 or other dedicated computing unit of the decoding device than carries out the process of object classification.

The scalable feature stream is to be understood as the feature bitstream 46, which will be constructed in such a way as to allow for a different type of operation of the classification process in the decoding device due to desired limitation and/or direction of the classification process and/or due to capabilities of the computing unit of the decoding device carrying out the process, possessed at a given moment and/or resulting from a specific application of the calculation capabilities. Further, additional/extra information may be added (implicitly or explicitly) to the scalable feature stream to assist the decoding device in the classification process. The additional/extra information may be information related to priorities, indicated for example with priority values, of the features in the feature stream as elaborated further below.

Different type of scalability of the features stream can be applied in the embodiments of the present disclosure. In the following, details of several types of scalability will be elaborated. The elaborated types of scalability are not to be seen in any way as limiting to the present disclosure.

The different types of scalability may comprise temporal scalability, spatial scalability, quality scalability and hybrid scalability. In the different types of scalability priority is set on different aspects of the classification process. Therefore, in the different types of scalability the priorities of the features, indicated for example with priority values, are based on different aspects of the classification process.

In the temporal scalability, priority is set to the duration of the classification process, performed in the decoding device. In the spatial scalability, priority is set to a specific area where the classification process is carried out, performed in the decoding device. In the quality scalability, priority is set on grading the quality of the classification process, performed in the decoding side. In the hybrid scalability two different scalability types from the three above mentioned scalability types: quality, spatial, and temporal, or all three scalability types can be used together.

Here below further details of the different scalability types are described.

### a) Temporal Scalability

The temporal scalability enables for classification and recognition of objects on devices with different processing/computing power.

If the decoding device, or more specifically the computing unit of the decoding device, has low processing/computing power, then an application or program for object classification running on such computing unit does not have the ability to fully process or in other words to classify objects in a specified unit time (also called allocated time slot for object classification process) based on all features sent in the features bitstream 46.

Therefore, the present disclosure proposes to reorganize the standard stream of features into scalable feature stream (in this case temporarily scalable) and to add (implicitly or explicitly) additional/extra information to it, such as priority information, which will make it possible for the computing unit of the decoding device to perform the object classification process only on a selected set of features.

In other words, the decoding device will select a group of features from the stream (for example one or more subsets of features) based on the priority information (which may be expressed with a priority value) according to the selected type of scalability and according to its capabilities. On the other hand, a decoding device with a computing unit with high computational power can processes the whole stream of features (or feature descriptors) sent to it.

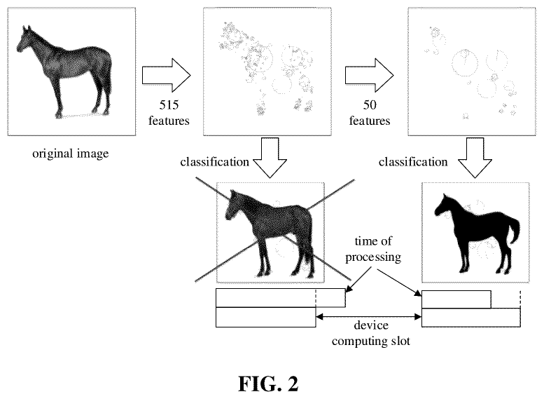

FIG. 2 shows schematically the difference in the computation time for the object classification process in case of classification on the basis of all the features in the stream and in case of classification on the basis of a limited set of features which is temporally scalable feature stream.

The original picture (input picture or source picture) comprises an object (in this case a horse) that should be classified in the decoding device. When the number of extracted features is a predetermined number, for example when the number of extracted features is 515 features and all extracted features are comprised in the features stream and are used for object classification the time of processing for the object classification process by the decoding device is higher than the possible time slot allocated for the object classification process to the decoding device such that the object classification process cannot be carried out (lower left part in FIG. 2).

On the other hand, the temporally scalable feature stream is limited to a lower number of features, for example 50 features. When the temporally scalable feature stream is used for the classification process by the decoding device than the time for processing by the decoding device is shorter than the time slot allocated to for the classification process to the decoding device. In this case a rough classification is possible and is carried out (lower left part of FIG. 2).

### b) Spatial Scalability

In this type of scalability, the object classification depends on the spatial position in the of the object in the picture.

The classification/recognition process begins from defined position in the picture toward the outside of the picture. Depending on the available processing/computing power of the decoding device, the classification/recognition area is expanded, using an increased number of features.

The present disclosure proposes different types of scanning or expansion of the classification/recognition area:

i) spiral scanning (spiral expansion of the classification/recognition area) involves classification of objects from the center of the picture to the outside of the picture for applications with recognition of the main object presented in the scene (focused view on the center of the picture).

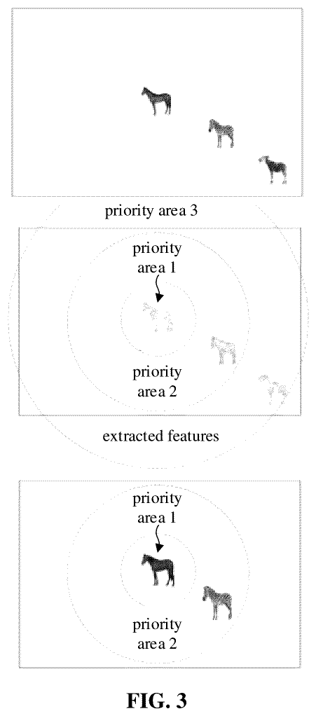

This is schematically shown in FIG. 3. In the top of the figure the original picture is shown, in the middle the extracted features and an example of definition of different priority areas (priority area 1, priority area 2 and priority area 3) are shown, and in the bottom classified objects according to priority 1 and priority 2 scalable feature stream with spatial scalability (spiral scanning option) are shown. In this case it is enabled that two objects are classified.

ii) scanning from the bottom to top of the picture involves classification of objects from the bottom to the top of the picture for applications with natural scene recognition.

Less important objects in the picture outside the center of the picture as in the spiral scanning elaborated under i) above, or at the top of the image as in the scanning elaborated under ii) above are classified when the decoding device has adequate computing power. When the decoding device does not have adequate computing power, the classification is limited to using only the set of features indicated by the encoder's spatial scalability priorities (for example subset of features assigned with priority values: priority 1 or priority 1 and priority 2 shown in FIG. 3).

Therefore, the present disclosure proposes reorganization of the standard stream of features into scalable feature stream. Additional/extra information, such as priority information, is added (implicitly or explicitly) to the scalable feature stream. This will enable the decoding device to perform the classification process only on a selected set of features (the decoding device selects a group of features from the stream based on the priority information (which may be expressed with one or more priority values according to the selected type of scalability and according to its capabilities. A decoding device with a computing unit with high computation power can processes the whole stream of features (or feature descriptors) sent to it.
c) Quality Scalability

The quality scalability enables for differentiation between inter-class and intra-class classification of objects.

The application or program running on the decoding device can decide whether it classifies, for example only the main classes of objects, such as but not limited to animal, car, building (the so-called inter-class classification), or classifies objects more precisely, for example zebra, horse, okapi, (the so-called intra-class classification).

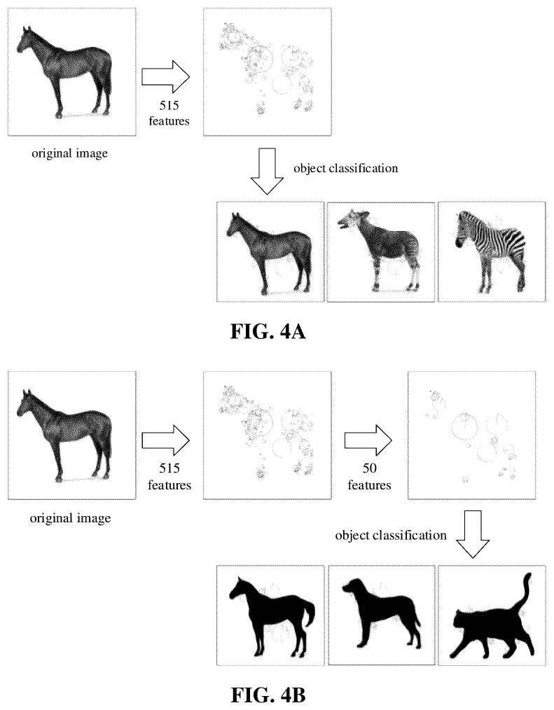

This is shown schematically in FIGS. 4A and 4B. FIGS. 4A and 4B show in the top the full feature stream, and in the bottom the selected features from scalable feature stream with quality scalability mode for intra-class classification and inter-class classification, respectively (results of classification in order of high score of classification for intra-class classification and inter-class classification, respectively).

If the decoding device has a computing unit with small computing capabilities, it can choose a quality scalability mode based on a scalable feature stream (for example limited to 50 features) and make a classification based on the rough features indicated by the given priority (and hence perform inter-class classification) as shown in FIG. 4B. If the decoding device has a computing unit with higher computing capabilities, it can select a higher priority and classify the objects on the basis of a wider set of features (for example the extracted 515 features), which causes distinguishing of the objects inside the object class (and hence intra-class classification) as shown in FIG. 4A.

Therefore, the present disclosure proposes reorganization of the standard stream of features into scalable feature stream. Additional/extra information, such as priority information, is added (implicitly or explicitly) to the scalable feature stream. This will enable the decoding device to perform the classification process only on a selected set of features (the decoding device selects a group of features from the stream based on the priority information (which may be expressed with one or more priority value) according to the selected type of scalability and according to its capabilities). A decoding device with a computing unit with high computation power can processes the whole stream of features (or feature descriptors) sent to it.

Accordingly, the present disclosure enables that the functionality of the feature stream usage is increased. The creating of a scalable feature stream will enable control of the classification process on the decoding side without engaging additional computing power to evaluate the features. This process of formation of a scalable feature stream will be performed by the encoder device according to the embodiment of the present disclosure.

According to the present disclosure it is also possible to set the feature set arbitrarily by the encoding device if the encoding device knows the communication link parameters between the encoding device and the decoding device (eg. bitframe for features stream). In such a situation the encoding device sets appropriate flags in the scalable feature stream (type of scalability and priority of the features).

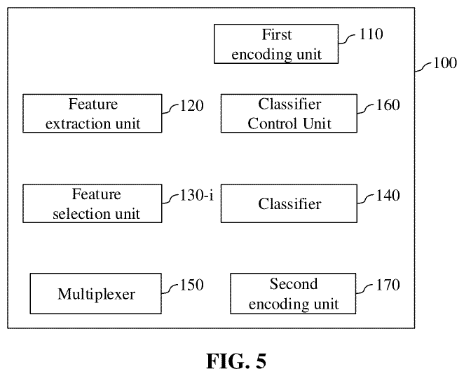

FIG. 5 shows the functional components of the encoding device 100 for processing visual information according to the embodiment of the present disclosure. These functional components may be realized by dedicated hardware components or may be realized by computer programmed processing of one or more processing resources such as one or more processing units of a data processing device or a computing unit. The data processing device or computing unit may be any suitable equipment such as data centre, server, data storage and so on. More specifically, a computer program or an application comprising code may be stored in the data processing device or computing which, when executed, instructs the one or more processing units or resources to carry out the functions described below.

The encoding device 100 comprises means (not shown in the figure) for obtaining picture data 41. The obtained picture data 41 may be picture data forming or being part of any kind of picture 31. The picture 31 may be a picture captured by an image/picture capturing device, for example a camera. The picture 31 may also be a picture generated by an image/picture generating device, for example with means such as computer graphic processing means. Further, the picture may be a monochromatic picture or may be a colour picture. Moreover, the picture may be a still picture or may be a moving picture, such as a video. The video may comprise one or more pictures.

The encoder device 100 comprises further a first encoding unit 110. The first encoding unit 110 generates and outputs an encoded picture data 45. The first encoding unit 110 generates encoded picture data 45 by performing an encoding to the picture data 41. The encoding may comprise performing compressing of the picture data 41. In the following, the words encoding and compressing may be interchangeably used. The encoded or compressed picture data 45 may be represented as a bitstream 45 also called picture bitstream 45 which is outputted to a communication interface (not shown in the figure) that receives the outputted picture bitstream 45 and transmits it to a further device via any suitable network and data communication infrastructure 60. The further device may be a decoding device 2 for decoding or decompressing the picture bitstream 45 to obtain a reconstructed picture data 48 to thereby generate the reconstructed picture 32. The further device may also be an intermediate device that forwards the picture bitstream 45 to the decoding device 2.

The first encoder unit 110 which generates picture bitstream 45 by performing encoding to the picture data 41 may apply various encoding methods applicable for encoding the picture data 45. More specifically, the first encoder unit 110 may apply various encoding methods applicable for encoding still pictures and/or videos. The first encoder unit 110 applying various encoding methods applicable for encoding still pictures and/or videos may comprise the first encoder unit applying a predetermined encoder. Such encoder may comprise encoder for encoding pictures or videos such as any one of the Joint Photographic Experts Group, JPEG, JPEG 2000, JPEG XR etc., Portable Network Graphics, PNG, Advanced Video Coding, AVC (H.264), Audio Video Standard of China (AVS), High Efficiency Video Coding, HEVC (H.265), Versatile Video Coding, VVC (H.266) or AOMedia Video 1, AV1 encoder.

The encoder device 100 comprises further a feature extraction unit 120. The feature extraction unit 120 extracts a plurality of features 42 from the picture data 41. The plurality of extracted features 42 may also be referred to as a set of extracted features 42. The extracted features 42 may be small patches in the picture data 41. Each feature normally comprises a feature key point and a feature descriptor. The feature key point may represent the patch 2D position. The feature descriptor may represent visual description of the patch. The feature descriptor is generally represented as a vector, also called a feature vector.

Several such features may form a definition of an object class (for example object class of house, person, animal and so on). If a predetermined number of extracted features 42 extracted from the picture data 41 from one or more definitions of one specific object class are in the picture data 41, then the picture data 41 may be classified as containing the specific object class. In other words, the specific object may be recognized in the picture data 41. Also, the features may be classified as belonging to the specific object class. The picture data 41 may comprise more than one object classes.

The feature extraction unit 120 may apply a predetermined feature extraction method to obtain the set of extracted features 42. In one embodiment the predetermined feature extraction method may result in the extraction of discrete features. For example, the feature extraction method may comprise any one of scale-invariant feature transform, SIFT, method, compact descriptors for video analysis, CDVA, method or compact descriptors for visual search, CDVS, method.

In other embodiment the predetermined feature extraction method may also apply linear or non-linear filtering. For example, the feature extraction unit 120 may be a series of neural-network layers that extract features from the obtained image through linear or non-linear operations. The series of neural-network layers may be trained based on a given data. The given data may be a set of images which have been annotated with what object classes are present in each image. The series of neural-network layers may automatically extract the most salient features with respect to each specific object class.

The encoding device comprises further a plurality of feature selection units 130. Here, plurality is to be understood as equal or more than two. For conciseness only one feature selection unit 130-i is shown in FIG. 2. Each feature selection unit 130-i selects one or more features.

The encoding device 100 comprises further a plurality of classifiers 140. Here, a plurality is to be understood as equal to or more than two. For conciseness only one classifier 140-i is shown in FIG. 2. The number of classifiers 140 is equal to the number of feature selection units 130. In particular, each feature selection unit 130-i is coupled to one classifier 140-i.

Each classifier 140-i may be assigned to one object class. Each classifier 140-i being assigned to one object class may be understood as each classifier 140-i classifying a received feature in the assigned object class. Further, the object class assigned to one classifier may be equal or different than the object class assigned to a different classifier. Each classifier 140-i may also be assigned to more than one object class.

The encoding device 100 comprises further a multiplexer 150. The multiplexer 150 multiplexes the selected features outputted by the plurality of feature selection units 130 and outputs the features for encoding. The multiplexer 150 may comprise one input for each feature selection unit 130.

The encoding device 100 comprises further a classifier control unit 160. The classifier control unit 160 controls the ordering of the features selected by the plurality of feature selection units 130 and further controls the outputting of the features by the multiplexer 150. In general, the classifier control unit 160 controls the organization of the feature stream.

The encoding device 100 comprises further a second encoding unit 170. The second encoding unit 170 generates encoded or compressed features by performing an encoding or compression to the features outputted by the multiplexer 150. The encoding may comprise performing compressing of the outputted features. The encoded or compressed features are outputted as a feature bitstream 46 to a communication interface (not shown in the figure) that receives the outputted features bitstream 46 and transmits it to a further device via any suitable network and data communication infrastructure. The further device may be a decoding device for decoding or decompressing the features bitstream 46 to obtain reconstructed features 49. The further device may also be an intermediate device that forwards the features bitstream to the decoding device.

Similar to the first encoding unit 110 which may generate picture bitstream 45 by performing encoding or compressing to the picture data 41 by applying various encoding methods applicable for encoding the picture, the second encoder unit 170 may apply various encoding methods applicable for encoding or compressing the features. More specifically, the second encoding unit 170 may apply various encoding methods applicable for encoding still pictures and/or videos. For example, the second encoding unit 170 may apply encoding methods including applying encoders like Joint Photographic Experts Group, JPEG, JPEG 2000, JPEG XR etc., Portable Network Graphics, PNG, Advanced Video Coding, AVC (H.264), Audio Video Standard of China (AVS), High Efficiency Video Coding, HEVC (H.265), Versatile Video Coding, VVC (H.266) or AOMedia Video 1, AV1 encoder. The first encoding unit 110 and the second encoding unit 170 may apply the same encoder but may also apply different encoders.

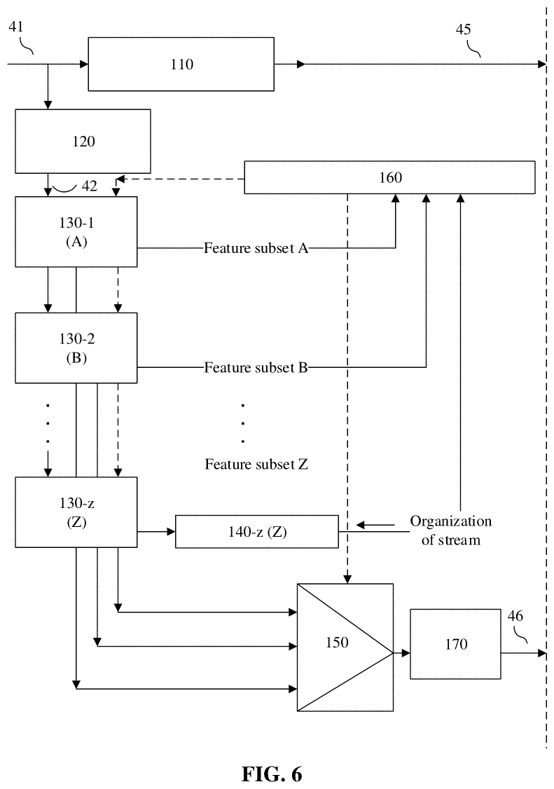

FIG. 6 shows schematically further details of the encoding device according to the embodiment of the present disclosure.

In the following an algorithm performed by the encoding device 100 according to the embodiment of the present disclosure is described with reference to FIG. 6.

The encoding device 100 (using the means for obtaining an image) obtains a picture data 41 of the original picture 31. The picture data 41 is fed or input to the first encoding unit 110. As elaborated above, the first encoding unit 110 encodes or compresses the picture data 41 of the original image to generate the picture bitstream 45.

The obtained picture data 41 is also fed or input to the feature extraction unit 120. The feature extraction unit 120 extracts a set of features, also called a set of extracted features 42 by performing feature extraction process. More specifically, the feature extraction unit 120 extracts the set of features by applying a predetermined feature extraction method as elaborated above. The feature extraction unit 120 determines a set of key points by performing feature extraction process. For simplicity, the set of key points will be called set of features X. For all N extracted key points (N being the number of extracted key points), at least the following parameters are available: the position of the key point [x,y], the orientation angle, the strength of the response, the radius of the neighbourhood and the gradients of the neighbourhood. These parameters form together the descriptor of the key point, generally represented as a vector, also called a feature vector. These are the parameters that are determined by most of the known feature descriptors (feature extraction methods) such as the SIFT or CDVS feature extraction methods elaborated above.

The set of extracted features 42 is further iteratively divided to one or several subsets of features A, B, . . . ,Z by processing the extracted features by the plurality of feature selection units 130 and classifiers 140 as elaborated below.

In the following it will be assumed that the encoding device 100 comprises Z classifiers 140-1, 140-2, . . . , 140-z and Z feature selection units 130-1, 130-2, . . . 130-z. The number Z is a variable number. More specifically, the number Z is the number resulting from the number of assumed possible priorities of the features. The priorities may be indicated with priority values.

The higher the priority of a feature, the more required is the use of this feature or feature group (subset) in the decoding device. The priorities in the above-elaborated types of scalability may mean the following:
a) In temporal scalability—features that should be used first in the classification so that the time of processing needed by the decoding device can be fitted into the time slot allocated for the object classification processing to the decoding device so that a classification result is obtained have higher priority. If the time slot is larger, more features of lesser importance (or lower priority) can be added to the object classification process, which will improve the object classification process. If the object classification process is started with less important features this may result in the time for processing by the decoding device not fitting into the decoding device's allocated time slot and thus the decoding device may not being able to obtain a classification result at all.
b) In spatial scalability, the use of higher priority features means using features in the classification process starting with the features located in the image from the place where the analysis starts (center of the image or from bottom to top as elaborated above). Adding less important features (features with lower priority) means expanding the classification area and thus using features that are further away from where the features start.
c) In quality scalability, the use of higher-priority features allows for a rough classification of objects (inter-class classification) first. By adding less important features (features with lower priority) the quality of the classification processed is improved by moving to an intra-class classification. Here it is noted that the priority of using features in the classification process is not equal to the higher quality of the classification process.

The above may accordingly be also seen as one or more rules for determining the priority and/or their respective priority values. In general, the type of scalability may also be seen as a requirement or a rule based on which the priorities (and/or the priority values to indicate the priorities) are determined.

The N features (N key points) in the extracted set of features X are sorted based on a predetermined criterion according to the type of scalability. Details of the predetermined criterion for the different types of scalability are described further below.
a) Temporal scalability-for temporal scalability the N features are sorted according to the strength of key point responses of the features and then according to the time needed to use a given number of features in the classification process in the decoding device. This time is initially estimated for a pre-determined, fixed set of features (or test set of features), taking into account a typical classification process and determination of a metric for comparing the distance of points in D-dimensional space.
b) spatial scalability-for spatial scalability the N features are sorted according to the following order: distance of the key point position of the features from the position where the classification process starts, which may be center of the image or bottom of the image as elaborated above, and then in order of the key point response strength.
c) Quality scalability-for quality scalability the N features are sorted according to the strength of key point responses.

Then an iterative process is performed, details of which are described here below.

In the iterative process, the feature set X is divided into subsets A, B . . . Z in such a way that the entire sorted feature set X (which is sorted according to the type of scalability as elaborated above) is first divided into two subsets using only the feature selection unit 130-1 marked as A and the classifier 140-1 marked as A in FIG. 6. The feature selection unit 130-1 marked as A and the classifier 140-1 marked as A are used to mark the final subset of features A (feature subset A) as the one with the highest priority. In other words, a highest priority value may be assigned to the feature subset A, for example priority value of 1.

Then by eliminating the features of the feature subset A from the feature set X, the feature selection unit marked as B 130-2 and the classifier marked as B 140-2 in FIG. 6 are employed for designating (or determining) a feature subset B. The feature selection unit marked as B 130-2 and the classifier marked as B 140-2 are used to designate (or determine) the subset of features B (feature subset B) as the one with lower priority than subset of features A. In other words, a priority value which is lower than the priority value assigned to feature subset A may be assigned to the feature subset B, for example priority value of 2. The priorities, and accordingly the priority values for indicating the priorities, are determined based on the above-elaborated rules or requirements.

Accordingly, the features of each feature subset that is designated after the feature subset A is designated are based on the residual features in the sorted set of feature.

Then by eliminating from the set X features of subset A and subset B the next feature selection unit 130-i and the next classifier 140-i are applied for designating (or determining) the next subset of features (feature subset i) with lower priority and etc. Here lower priority may mean for example a priority value which is lower than the priority value assigned to feature subset A and feature subset B. Accordingly, each feature subset designated (or determined) in a later step has lower priority (priority value) than the priorities (priority values) of the feature subsets determined in the previous steps.

The process of finding the matching of feature vectors consists of minimizing the distance between all the elements of vectors describing a significant point from the query set and all the elements of vectors describing each significant point from the searched set. A significant point may also be called a key point.

To compare sets of key points, distance measures defined on the feature vectors of key points are used. In general it can be assumed that two key points fa , fb E [symbol] ⁿ have feature vectors of m length: fₐ=[fₐ_{₁}, fₐ_{₂}, . . . fₐ_{ₘ}] and f_{b}=[f_{b}_{₁}, f_{b}_{₂}, . . . f_{b}_{ₘ}].

As elaborated above, the basic elements of the feature vector describing a significant point (or a key point) are: the position of the key point [x,y], the orientation angle, the strength of the response, the radius of the neighborhood and the gradients of the neighborhood.

The norm L1 and L2 represented with equations 1 and 2 given below respectively, are mainly used for distance measures in the embodiment of the present disclosure.

d(fₐ,f_{b})=Σᵢ₌₁^{m}|fₐ_{ᵢ}−f_{b}_{ᵢ}| (1)

(2) (2)

This distance measures are not to be seen as limiting since other distance measures may also be applied in the embodiment of the present disclosure such as, for example, the Camberra distance, represented with equation (3) given below and the Chebysev distance represented with equation (4) given below.

$$d ( {f}_{a} , {f}_{b} ) = {\sum }_{i = 1}^{m} \frac{\vert {f}_{{a}_{i}} - {f}_{{b}_{i}} \vert}{\vert {f}_{{a}_{i}} + {f}_{{b}_{i}} \vert} \qquad ( 3 )$$

$$d ( {f}_{a} , {f}_{b} ) = {max}_{i = 0}^{m} \vert {f}_{{a}_{i}} - {f}_{{b}_{i}} \vert \qquad ( 4 )$$

As a result of calculating the distance measures between the key points, different values are obtained for the different key points. It may happen that significant points (key points) do not have their equivalents in the compared set and in this case the values determined by the metrics will still indicate some calculated distances to other key points.

By comparing the sets of key points between a subset of the examined features and the set of features of reference objects from a database, (the set of features of reference objects being pre-determined and pre-stored), the sum of metrics of the distance between the closest key points of the objects is determined and a ranking list of classification/recognition results between the examined object and the objects from the database is created. In other words, a ranking list is formed for the key points. The mentioned database may be stored in a memory unit in the encoding device.

The algorithm of iterative division of the set is terminated in a given point of the selection/classification loop when the classification quality exceeds an assumed threshold. The classification quality is to be understood as the classification quality based on the already designated (or determined) or selected and classified features. When the algorithm of iterative division is terminated the subset is accordingly finalized (designated or determined) and the next subset is designated (or determined) accordingly.

The mentioned threshold is set according to the type of scalability. More specifically, different requirements apply in each type of scalability. These operations are performed in the classifier control unit 160. The classifier control unit 160 optimizes the assessment of the importance of features for all scalability types together.

The classifier control unit 160 determines at least one or more optimal codes for the priorities (and/or priority values) of the feature subsets depending on the number of assumed priorities and types of scalability. For example, the classifier control unit 160 may determine codes for indicating (to the decoding device) the priority value assigned to each subset of features, for example using one or more bits, based on the number of assumed priorities and types of scalability. These codes, or one or more rules for determining the codes, may also be shared between the encoding device and the decoding device, or may be pre-stored or pre-configured in the encoding device and the decoding device.

By complementing these codes with a bitstream of features and multiplexing the corresponding subsets of features by the multiplexer 150, the classifier control unit 160 creates a scalable feature stream. In other words, the classifier control unit 160 reorganizes the feature stream and thereby creates a scalable feature stream. Thus, the multiplexing is based on the priority value assigned to each subset of features.

The multiplexed scalable feature stream is fed into the second encoding unit 170 which generates the features bitstream 46. The features bitstream 46 is fed into the communication interface that transmits the features bitstream 46 to the decoding device 2 via any suitable network and data communication infrastructure.

On the deciding device 2 side the two bitstreams: the picture bitstream 45 and the features bitstream 46 generated as elaborated above are received. The decoding device 2 decodes the picture bitstream 45 so as to generate one or more reconstructed pictures and decodes (decompresses) the features bitstream 46 so as to generate one or more (decompressed) reconstructed features. The decoding device may also extract from the decompressed features bitstream 46 an information indicating the assigned priority values to the different feature subsets.

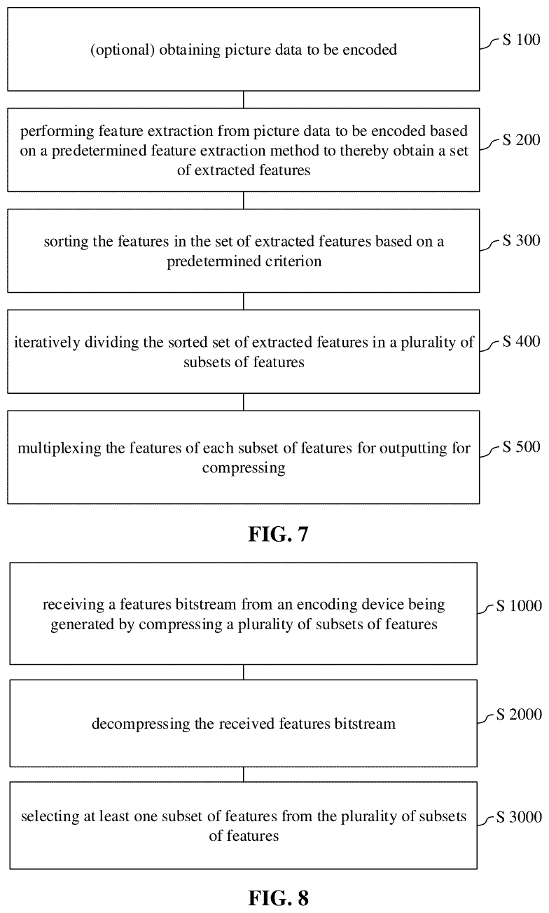

The method carried out in the encoding device is described further below with respect to FIG. 7.

In an optional step S100 picture data to be encoded is obtained.

In step S200 feature extraction from picture data to be encoded based on a predetermined feature extraction method to thereby obtain a set of extracted features is performed.

In step S300 the features in the set of extracted features are sorted based on a predetermined criterion.

In step S400 the sorted set of extracted features is iteratively dividing in a plurality of subsets of features, said plurality of subsets of features comprising a first subset of features and at least one further subset of features, wherein the first subset of features is assigned a priority value which is higher than the priority value assigned to the at the at least one further subset of features.

In step S500 the features of each subset of features for outputting are multiplexed for compressing, wherein the multiplexing is based on the priority value assigned to each subset of features.

In a further step (not shown in the figure) the multiplexed features are compressed for outputting to a decoder device side.

The method carried out in the decoding device is described further below with respect to FIG. 8.

In step S1000 a features bitstream from an encoding device is received. The feature bitstream, as elaborated above, is generated by compressing a plurality of subsets of features, said plurality comprising a first subset of features and at least one further subset of features, wherein the first subset of features is assigned a priority value which is higher than the priority value of the at least one further subset of features.

In step S2000 the received features bitstream is decompressed to thereby obtain decompressed plurality of subsets of features.

In an optional step, from the decompressed features bitstream an information indicating the assigned priority values to the different feature subsets may be extracted.

In step S3000 at least one subset of features is selected from the plurality of subsets of features based on the priority value assigned to each subset of features and the processing capabilities of the decoding device.

In summary, a method for visual feature processing processing in an encoding device and a decoding device and an encoding device and a decoding device has been elaborated.

With the elaborated method for visual feature processing in an encoding device and the elaborated encoding device the feature stream is organized into a scalable stream so that classification on the decoding side can be carried out according to certain rules. This rules may involve the priority values and the type of scalability.

For this purpose, as elaborated above, classification processes are additionally carried out in the encoding device in order to select the valuable features (from the point of view of unambiguity of classification) and the selected features are processed by the feature selection units and classifiers so that their stream is organized.

This approach allows organizing the original feature stream into a stream of independent or dependent features bitstream that enables the decoding device to achieve a faster classification of features into relevant objects, and/or a reduction in the computing power needed for the classification process, and/or unambiguity of classification both on the encoding device side and the decoding device side, and/or to clarify the object properties to data in dependent structures and/or rules for decoding the scalable feature stream.

Although detailed embodiments have been described, these only serve to provide a better understanding of the disclosure defined by the independent claims and are not to be seen as limiting.

1. A visual feature processing method in an encoding device, the visual feature processing method comprising:
performing feature extraction from picture data to be encoded based on a predetermined feature extraction method to thereby obtain a set of extracted features;
sorting the features in the set of extracted features based on a predetermined criterion;
iteratively dividing the sorted set of extracted features in a plurality of subsets of features, said plurality of subsets of features comprising a first subset of features and at least one further subset of features, wherein the first subset of features is assigned a priority value which is higher than the priority value assigned to the at least one further subset of features; and
multiplexing the features of each subset of features for outputting for compressing, wherein the multiplexing is based on the priority value assigned to each subset of features.

2. The method according to claim 1, further comprising:
compressing the multiplexed features of each subset of features using a predetermined compression encoder to thereby obtain a compressed features bitstream; and
outputting the compressed features bitstream to a decoding device.

3. The method according to claim 1, wherein the predetermined criterion is based on at least one of:
distance of a key point position of a feature from a position in the picture where an object classification process in a decoding device starts;
strength of key point responses of the features; or
time to use a pre-determined number of features in an object classification process in a decoding device, said time being pre-determined based on a pre-determined set of features.

4. The method according to claim 1, wherein said priority values are based on at least one of the following rules:
order of using the features in an object classification process in a decoding device so that the time for finishing an object classification process in the decoding device is within a predetermined time;
position of the features in the picture where analysis for object classification process in the decoding device starts; or
quality of the object classification process in the decoding device.

5. The method according to claim 1, wherein the number of subsets of features of the plurality of subsets of features is a predetermined number, said predetermined number corresponding to a predetermined number of priority values to be assigned to the plurality of subsets of features.

6. The method according to claim 1, wherein iteratively dividing the sorted set of extracted features in a plurality of subsets of features comprises:
in a first step iteratively determining the features in the said first subset of features to thereby designate the first subset of features; and
in a number of subsequent steps, iteratively determining the features in each further subset of features based on the residual features in the sorted set of features to thereby designate each further subset of features,
wherein the priority value assigned to the subset of features designated in a subsequent step is lower than the priority value assigned to the subset of features designated in the previous step.

7. The method according to claim 1, wherein iteratively determining the features in each subset of features comprises performing n times feature selection process and feature classification process.

8. The method according to claim 7, further comprising comparing sets of selected features by comparing sets of the respective key points of the selected features.

9. The method according to claim 8, wherein said comparing comprises calculating distance measures for said respective key points of the selected features.

10. The method according to claim 6, wherein the process of iteratively determining the features in each subset of features is terminated when a classification quality based on the determined features in the subset exceeds a predetermined threshold.

11. The method according to claim 1, further comprising determining codes for indicating the priority values of the features.

12. The method according to claim 1, further comprising complementing said determined codes with the corresponding subsets of feature and multiplexing the features of the subsets of features for outputting for compressing.

13. The method according to claim 1, wherein the picture data to be encoded include data that contains, indicates and/or can be processed to obtain an image, a picture, a stream of pictures/images, a video, a movie, and the like, wherein, in particular, a stream, video or a movie may contain one or more pictures.

14. The method according to claim 1, wherein the predetermined feature extraction method comprises neural-network based feature extraction method that applies linear or non-linear filtering.

15. The method according to claim 1, wherein the predetermined feature extraction method comprises any one of scale-invariant feature transform, SIFT, method, compact descriptors for video analysis, CDVA, method or compact descriptors for visual search, CDVS, method.

16. The method according to claim 1, further comprising obtaining picture data to be encoded.

17. The picture processing method of claim 1, further comprising
compressing the picture data using a predetermined compression encoder to thereby obtain a picture bitstream, and
outputting said picture bitstream to a decoding device.

18. An encoder device for visual feature processing, said encoder device comprising at least one processor and an access to a memory resource to obtain code that instructs said at least one processor during operation to:
perform feature extraction from picture data to be encoded based on a predetermined feature extraction method to thereby obtain a set of extracted features;
sort the features in the set of extracted features based on a predetermined criterion;
iteratively divide the sorted set of extracted features in a plurality of subsets of features, said plurality of subsets of features comprising a first subset of features and at least one further subset of features, wherein the first subset of features is assigned a priority value which is higher than the priority value assigned to the at the at least one further subset of features; and
multiplexing the features of each subset of features for outputting for compressing, wherein the multiplexing is based on the priority value assigned to each subset of feature.

19. A visual feature processing method in a decoding device, the method comprising:
receiving a features bitstream from an encoding device, said feature bitstream being generated by compressing a plurality of subsets of features, said plurality comprising a first subset of features and at least one further subset of features, wherein the first subset of features is assigned a priority value which is higher than the priority value assigned to the at the at least one further subset of features,
the method further comprising:
decompressing the received features bitstream to thereby obtain decompressed plurality of subsets of features; and
selecting at least one subset of features from the plurality of subsets of features based on the priority value assigned to each subset of features and the processing capabilities of the decoding device.

20. A decoder device for visual feature processing, said decoder device comprising at least one processor and an access to a memory resource to obtain code that instructs said at least one processor during operation to:
receive a features bitstream from an encoding device, said features bitstream being generated by compressing a plurality of subsets of features, said plurality comprising a first subset of features and at least one further subset of features, wherein the first subset of features is assigned a priority value which is higher than the priority value assigned to the at the at least one further subset of features,
decompress the received feature bitstream to thereby obtain decompressed plurality of subsets of features; and
select at least one subset of features from the plurality of subsets of features based on the priority value assigned to each subset of features and the processing capabilities of the decoding device.
